(19) United States
(12) Patent Application Publication
(10) Pub. No.: US 2012/0123723 A1
(43) Pub. Date: May 17, 2012

(54) METHODS FOR MITIGATING INTERACTIONS AMONG WIRELESS DEVICES IN A WIRELESS TEST SYSTEM

(76) Inventors: Wassim El-Hassan, San Jose, CA (US); Vishwanath Venkataraman, San Francisco, CA (US); Justin Gregg, San Francisco, CA (US)

(21) Appl. No.: 13/019,250

(22) Filed: Feb. 1, 2011

Related U.S. Application Data
(60) Provisional application No. 61/413,953, filed on Nov. 15, 2010.

(51) Int. Cl. G06F 19/00

(52) U.S. Cl. 702/108

(57) ABSTRACT

A test station may include a test host, a test unit, and a test chamber. Multiple devices under test (DUTs) may be placed in the test chamber during wireless testing. Radio-frequency signals may be conveyed between the test unit and the multiple DUTs using a conducted arrangement through a splitter-combiner circuit or using a radiated arrangement through a test antenna in the test chamber. The multiple DUTs may be synced to the test unit one DUT at a time (in series) or in parallel. The test host may direct the test unit to broadcast downlink signals at a given channel. The test host my direct a selected DUT to transmit uplink signals at the given channel or at a selected channel that is different from the given channel. The test unit may be used to perform desired measurement on the uplink signals transmitted from the selected DUT.

This application claims the benefit of provisional patent application No. 61/413,953, filed Nov. 15, 2010, which is hereby incorporated by reference herein in its entirety.

### BACKGROUND

This relates generally to testing wireless electronic devices and more particularly, to testing multiple electronic devices placed in a test chamber.

Wireless electronic devices typically include transceiver circuitry, antenna circuitry, and other radio-frequency circuitry that provides wireless communications capabilities. During testing, wireless electronic devices under test (DUTs) can exhibit different performance levels. For example, each wireless DUT in a group of DUTs can exhibit its own output power level, gain, frequency response, efficiency, linearity, dynamic range, etc.

The performance of a wireless DUT can be measured using a radio-frequency (RF) test station. An RF test station typically includes a test chamber, a test unit, and a test host. The test unit is connected to the test host. Arranged in this way, the test host configures the test unit to perform desired radio-frequency test measurements.

In conventional radio-frequency test arrangements, a wireless DUT is placed into the test chamber. The wireless DUT is connected to the test host using a control cable. The test host directs the test unit to broadcast downlink signals to the DUT over a wireless path or a wired path. The test host directs the DUT to synchronize (“sync”) to the downlink signals broadcast from the test unit. The DUT then transmits radio-frequency signals to the test unit. The test unit performs radio-frequency measurements by analyzing the radio-frequency signals transmitted from the DUT.

Once desired measurements have been obtained using the test unit, the DUT is disconnected from the test host (i.e., by unplugging the control cable from the DUT) and is removed from the test chamber. To test additional DUTs, an additional DUT is connected to the test host (i.e., by plugging the control cable into a corresponding mating connector in the additional DUT) and is placed into the test chamber. The test unit can then be used to obtain wireless performance measurements on the additional DUT.

Wireless testing using this conventional approach may be inefficient, because the process of connecting a DUT to the test host, placing the DUT in the test chamber, testing the DUT, removing the DUT from the test chamber, and disconnecting the DUT from the test host one DUT at a time is time-consuming.

It would therefore be desirable to be able to provide improved ways of performing wireless testing.

### SUMMARY

Test stations in a radio-frequency test system can be used to perform wireless testing on wireless devices under test (DUTs). Each test station may include a test host, a test unit (or tester), and a test chamber. During wireless testing, more than one DUT may be placed within the test chamber.

In one suitable test arrangement, the tester may be coupled to the multiple DUTs in the test chamber through a splitter-combiner coupling circuit. In particular, the DUTs may include transceiver circuits that are electrically connected to the coupling circuit through radio-frequency cables. Testing the DUTs using this conducted test setup bypasses over-the-air transmission.

In another suitable test arrangement, radio-frequency signals may be conveyed between the tester and the multiple DUTS through a test antenna that is placed within the test chamber. The test antenna may transmit and receives radio-frequency signals to and from the multiple DUTs in the test chamber. Testing the DUTs using this radiated test setup takes into account the effect of over-the-air transmission.

Whether the multiple DUTs are tested using the conducted arrangement or the radiated arrangement, the DUTs may be synchronized (synced) to the tester in series or in parallel.

During serial synchronization processes, each DUT is synced to the tester one at a time. The test host may direct the tester to broadcast downlink test signals at a given channel. The test host may direct a selected one of the multiple DUTs to sync to the downlink test signals broadcast by the tester. When the selected DUT has properly synced to the downlink test signals, the selected DUT may transmit uplink signals at the given channel to the tester. The tester may then perform desired measurements on the uplink signals transmitted by the selected DUT. The selected DUT may be unsynchronized from the tester before testing and syncing a successive DUT.

During parallel synchronization processes, the multiple DUTs may simultaneously sync to the tester in parallel. The test host may direct the tester to broadcast downlink test signals at a given channel. The test host may direct each one of the multiple DUTs to simultaneously sync to the downlink test signals broadcast by the tester (e.g., each of the multiple DUTs may transmit uplink signals at the given channel). The test host may direct a selected one of the multiple DUTs to transmit uplink signals at a selected channel that is different from the given channel. The tester may then analyze and perform desired measurements on the uplink signals at the selected channel. The test host may then reconfigure the selected DUT to transmit uplink signals at the given channel before testing a successive DUT. The successive DUT need not be synced to the tester, because the each of the multiples has previously been synced to the tester during the parallel synchronization step.

Further features of the present invention, its nature and various advantages will be more apparent from the accompanying drawings and the following detailed description.

### BRIEF DESCRIPTION OF THE DRAWINGS

FIG. 1 is a diagram of an illustrative wireless device under test with radio-frequency circuitry in accordance with an embodiment of the present invention.

FIG. 2 is a diagram of illustrative test stations each connected to computing equipment and each including a test host, a tester, a coupling circuit, and a test chamber in accordance with an embodiment of the present invention.

FIG. 3 is a diagram of illustrative test stations each connected to computing equipment and each including a test host, a tester, a test antenna, and a test chamber in accordance with an embodiment of the present invention.

FIG. 4 is a flow chart of illustrative steps involved in testing multiple devices under test that are placed within a test chamber and in syncing the devices under test in series in accordance with an embodiment of the present invention.

FIG. 5 is a flow chart of illustrative steps involved in testing multiple devices under test that are placed within a test chamber and in syncing the devices under test in parallel in accordance with an embodiment of the present invention.

### DETAILED DESCRIPTION

Wireless electronic devices include antenna and transceiver circuitry that support wireless communications. Examples of wireless electronic devices include desktop computers, computer monitors, computer monitors containing embedded computers, wireless computer cards, wireless adapters, televisions, set-top boxes, gaming consoles, routers, or other electronic equipment. Examples of portable wireless electronic devices include laptop computers, tablet computers, handheld computers, cellular telephones, media players, and small devices such as wrist-watch devices, pendant devices, headphone and earpiece devices, and other miniature devices.

Devices such as these are often provided with wireless communications capabilities. For example, electronic devices may use long-range wireless communications circuitry such as cellular telephone circuitry to communicate using cellular telephone bands at 850 MHz, 900 MHz, 1800 MHz, and 1900 MHz (e.g., the main Global System for Mobile Communications or GSM cellular telephone bands). Long-range wireless communications circuitry may also handle the 2100 MHz band.

Electronic devices may use short-range wireless communications links to handle communications with nearby equipment. For example, electronic devices may communicate using the WiFi® (IEEE 802.11) bands at 2.4 GHz and 5 GHz and the Bluetooth® band at 2.4 GHz. It is sometimes desirable to receive satellite navigation system signals such as signals from the Global Positioning System (GPS). Electronic devices may therefore be provided with circuitry for receiving satellite navigation signals such as GPS signals at 1575 MHz.

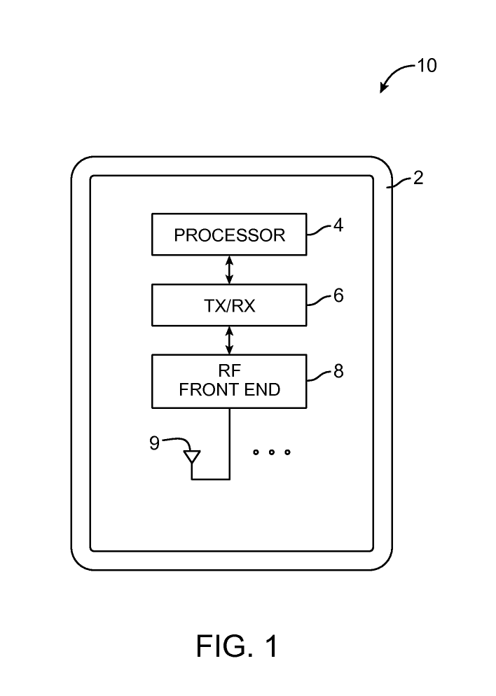

In testing environments, the wireless electronic devices are sometimes referred to as devices under test (DUTs). FIG. 1 shows an example of a test device such as DUT 10. DUT 10 may be a portable electronic device, a computer, a multimedia device, or other electronic equipment. DUT 10 may have a device housing such as housing 2 that forms a case for its associated components.

DUT 10 may have storage and processing circuitry such as storage and processing circuitry 4. Storage and processing circuitry 4 may include storage such as hard disk drive storage, nonvolatile memory (e.g., flash memory or other electrically-programmable-read-only memory configured to form a solid state drive), volatile memory (e.g., static or dynamic random-access-memory), etc. Processing circuitry in storage and processing circuitry 4 may be used to control the operation of device 10. This processing circuitry may be based on one or more microprocessors, microcontrollers, digital signal processors, application specific integrated circuits, etc.

Circuitry 4 may interact with a transceiver circuit such as transceiver circuit 6. Transceiver circuit 6 may include an analog-to-digital converter (ADC), a digital-to-analog converter (DAC), a digital down-converter (DDC), and a digital up-converter (DUC).

In a scenario in which DUT 10 is transmitting, circuitry 4 may provide digital data (e.g., baseband signals) to the DUC. The DUC may convert or modulate the baseband digital signals to an intermediate frequency (IF). The IF digital signals may be fed to the DAC to convert the IF digital signals to IF analog signals. The IF analog signals may then be fed to an RF front end such as RF front end 8.

When DUT 10 is receiving wireless signals, RF front end 8 may provide incoming IF analog signals to the ADC. The ADC may convert the incoming IF analog signals to incoming IF digital signals. The incoming IF digital signals may then be fed to the DDC. The DDC may convert the incoming IF digital signals to incoming baseband digital signals. The incoming baseband digital signals may then be provided to circuitry 4 for further processing. Transceiver circuit 6 may either up-convert baseband signals to IF signals or down-convert IF signals to baseband signals. Transceiver block 6 may therefore sometimes be referred to as an IF stage.

RF front end 8 may include circuitry that couples transceiver block 6 to one or more antenna such as antenna 9. RF front end 8 may include circuitry such as matching circuits, band-pass filters, mixers, low noise amplifier circuitry, power amplifier circuitry, etc. Circuitry 4, transceiver block 6, RF front end 8, and antenna 9 may be housed within housing 2.

In the scenario in which DUT 10 is transmitting, RF front end 8 may up-convert the IF analog signals from transceiver block 6 to RF analog signals (e.g., the RF signals typically have higher frequencies than the IF signals). The RF analog signals may be fed to antenna 9 for broadcast. If desired, more than one antenna may be used in DUT 10.

In the scenario in which DUT 10 is receiving wireless signals, antenna 9 may receive incoming RF analog signals from a broadcasting device such as a base transceiver station, network access point, etc. The incoming RF analog signals may be fed to RF front end 8. RF front end 8 may down-convert the incoming RF analog signals to IF analog signals. The IF analog signals may then be fed to transceiver circuit 6 for further data processing.

Examples of cellular telephone standards that may be supported by the wireless circuitry of device 10 include: the Global System for Mobile Communications (GSM) “2G” cellular telephone standard, the Evolution-Data Optimized (EVDO) cellular telephone standard, the “3G” Universal Mobile Telecommunications System (UMTS) cellular telephone standard, the “3G” Code Division Multiple Access 2000 (CDMA 2000) cellular telephone standard, and the “4G” Long Term Evolution (LTE) cellular telephone standard. Other cellular telephone standards may be used if desired. These cellular telephone standards are merely illustrative.

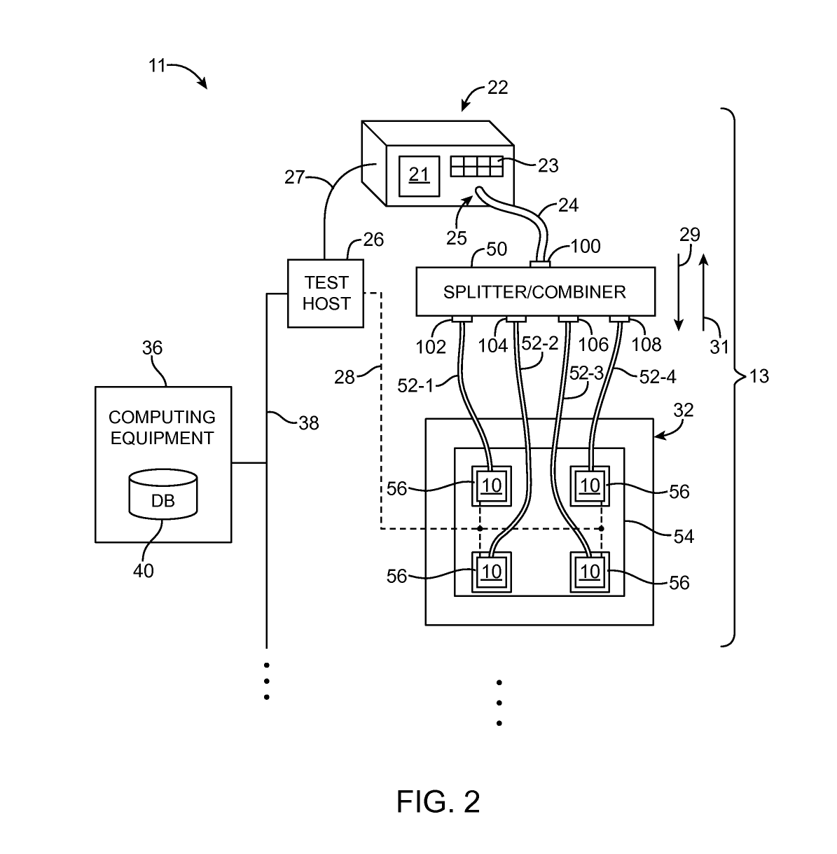

During testing, many wireless devices (e.g., hundreds, thousands, or more of DUTs 10) may be tested in a test system such as test system 11 of FIG. 2. Test system 11 may include test accessories, computers, network equipment, tester control boxes, cabling, test chambers, test antennas within the test chambers, and other test equipment for transmitting and receiving radio-frequency test signals and gathering test results. Test system 11 may include multiple test stations such as test stations 13. There may, for example, be 80 test stations 13 at a given test site. Test system 11 may include any desired number of test stations to achieve desired test throughput.

Each test station 13 may include a test host such as test host 26, a test unit such as test unit 22, and a test chamber such as test chamber 32. Test host 26 may, for example, be a personal computer or other types of computing equipment.

Test unit (sometimes referred to as a tester) 22 may be a radio communications tester of the type that is sometimes referred to as a test box or a radio communications tester. Tester 22 may, for example, be the CMU300 Universal Radio Communication Tester available from Rohde & Schwarz. Test unit 22 may be used to perform radio-frequency signaling tests for a variety of different radio-frequency communications bands and channels.

Test unit 22 may be operated directly or via computer control (e.g., when test unit 22 receives commands from test host 26). When operated directly, a user may control test unit 22 by supplying commands directly to the test unit using the user input interface of the test unit. For example, a user may press buttons in a control panel 23 on the test unit while viewing information that is displayed on a display 21 in the test unit. In computer controlled configurations, a test host such as computer 26 (e.g., software running autonomously or semi-autonomously on the computer) may communicate with the test unit (e.g., by sending and receiving data over a wired path 27 or a wireless path between the computer and the test unit).

During testing, more than one DUT 10 may be placed within test chamber 32. Test chamber 32 may have a cubic structure (six planar walls), a rectangular prism-like structure (six rectangular walls), a pyramid structure (four triangular walls with a rectangular base), or other suitable structures.

The multiple DUTs 10 may be attached to a test structure such as test structure (test tray) 54 within test chamber 32. Test tray 54 may include test fixtures 56. During testing, DUTs 10 may mate with corresponding test fixtures 56. For example, each test fixture 56 may have an RF connector mounted on its surface. DUT 10 may have a corresponding RF connector that is used to mate with the RF connector of test fixture 56 during test.

DUTs 10 may be coupled to test host 26 through wired path 28 (e.g., data signals may be conveyed between test host 26 and a respective DUT through test fixture 56 over data path 28). Connected in this way, test host 26 may send commands over bus 28 to configure DUTs 10 to perform desired operations during testing. Test host 26 and DUTs 10 may be interconnected using a Universal Serial Bus (USB) cable, a Universal Asynchronous Receiver/Transmitter (UART) cable, or other types of cabling (e.g., bus 28 may be a USB-based connection, a UART-based connection, or other types of connections).

In one suitable arrangement, DUTs 10 may be coupled to test unit (tester) 22 through a radio-frequency coupler such as RF coupler 50. As shown in FIG. 2, coupling circuit 50 may have a given port 100 that is connected to tester 22 through radio-frequency cable 24 (e.g., a coaxial cable). Coupling circuit 50 may include additional ports each of which is connected to respective DUTs 10. For example, circuit 50 may have a first port 102 that is electrically connected to a first corresponding DUT through RF cable 52-1, a second port 104 that is electrically connected to a second corresponding DUT through RF cable 52-2, a third port 106 that is electrically connected to a third corresponding DUT through RF cable 52-3, and a fourth port 108 that is electrically connected to a fourth corresponding DUT through RF cable 52-4.

Cable 52-1 may be directly connected to transceiver 6 of first DUT 10. Cable 52-2 may be directly connected to transceiver 6 of second DUT 10. Cable 52-3 may be directly connected to transceiver 6 of third DUT 10. Cable 52-4 may be directly connected to transceiver 6 of fourth DUT 10. Testing DUTs 10 using this type of arrangement may be referred to as conducted testing, because directly tapping into transceivers 6 bypasses over-the-air (radiated) transmission (e.g., antennas 9 of DUTs 10 are not in use during conducted testing). Cables 52-1, 52-2, 52-3, and 52-4 may be, for example, a miniature coaxial cable with a diameter of less than 2 mm (e.g., 0.81 mm, 1.13 mm, 1.32 mm, 1.37 mm, etc.), whereas cable 24 may be, for example, a cable with a diameter of about 2-5 mm (as an example).

Radio-frequency signals may be transmitted in a downlink direction (as indicated by arrow 29) from tester 22 to DUTs 10 through coupling circuit 50. During downlink signal transmission, test host 26 may direct tester 22 to generate RF test signals at its input-output (I/O) port 25. Circuit 50 may receive the test signals generated by test 22 through port 100. Circuit 50 may split the received signals into multiple reduced-power versions of the received signals. The reduced-power versions of the received signals may be routed to respective ports 102, 104, 106, and 108. Configured using this arrangement, DUTs 10 may each receive reduced-power versions of the test signals generated by tester 22. Coupler 50 used in this way during downlink transmission may therefore sometimes be referred to as a splitter.

Radio-frequency signals may be transmitted in an uplink direction (as indicated by arrow 31) from DUTs 10 to tester 22 through coupling circuit 50. During uplink signal transmission, test host 26 may direct DUTs 10 to simultaneously generate RF signals using transceiver circuits 6. Circuit 50 may receive the signals generated by the different DUTs 10 through ports 102, 104, 106, and 108 (as an example). Circuit 50 may combine the received signals into a single combined signal. The combined signal may be routed to tester 22 for analysis. Tester 22 may be used to perform desired radio-frequency measurements on the combined signal. Coupler 50 used in this way during uplink transmission may therefore sometimes be referred to as a combiner.

The test setup of FIG. 2 is merely illustrative. More than four DUTs 10 or less than four DUTs 10 may be mounted on tray 54 during test operations. Splitter/combiner circuit 50 may include a sufficient number of ports to accommodate the desired number of DUTs 10. For example, consider a scenario in which eight DUTs 10 are attached to tray 54. Circuit 50 may therefore include port 100 that is coupled to tester 22 and eight additional ports that are coupled to respective DUTs 10 (as an example).

Test tray 54 may or may not be placed within test chamber 32. If test chamber 32 is used, test chamber 32 may serve to isolate DUTs 10 that are placed within test chamber 32 from external sources of radiation, interference, and noise so that DUTs 10 are being tested in a controlled environment.

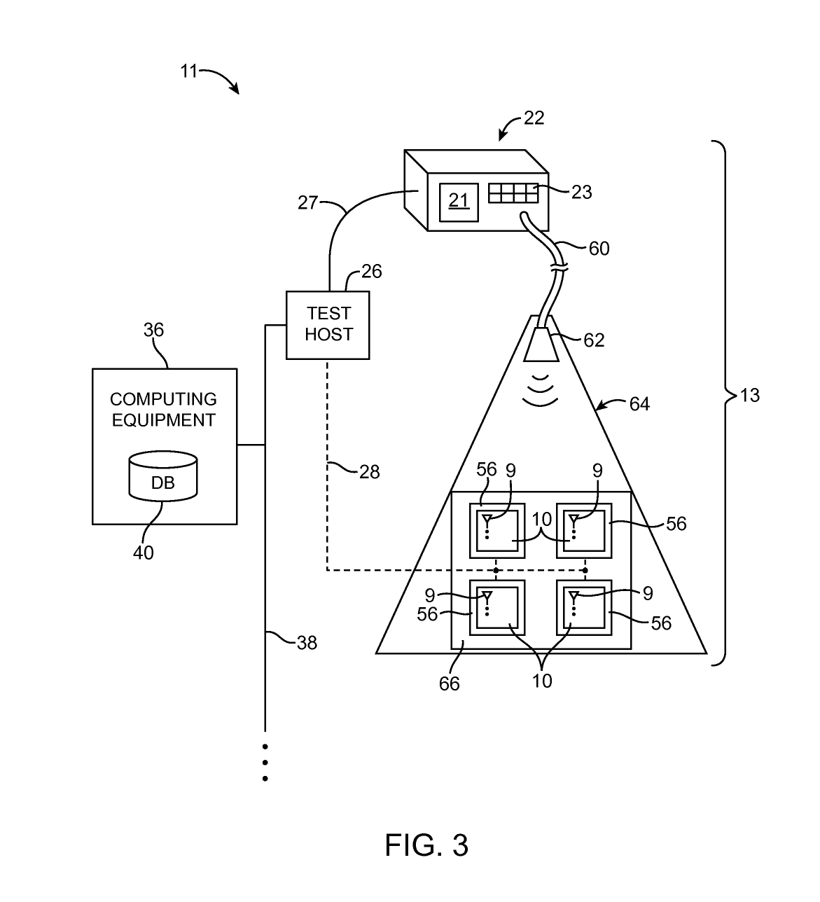

FIG. 3 shows another suitable arrangement of test stations 13. As shown in FIG. 3, test station 13 may be configured to perform over-the-air (OTA) testing (sometimes referred to as radiated testing). In the test setup of FIG. 3, tester 22 is connected to a test antenna such as test antenna 62 through RF cable 60. Antenna 62 may be a microstrip antenna such as a microstrip patch antenna, a horn antenna, or other types of antennas.

Test antenna 62 may be placed within a test chamber such as test chamber 64. Test chamber 64 may, for example, be a pyramidal-shaped transverse electromagnetic (TEM) cell. TEM cell 64 may be used to perform electromagnetic compatibility (EMC) radiated tests without interference from ambient electromagnetic environment.

Multiple DUTs 10 may be placed within test chamber 64 during wireless testing. DUTs 10 may be attached to DUT support structure 66 by mating with corresponding test fixtures 56 on structure 66.

During downlink signal transmission, tester 22 may generate radio-frequency test signals. Antenna 62 may wirelessly transmit the test signals to DUTs 10 in TEM cell 64 (as an example). Antennas 9 in DUTs 10 may receive the radiated test signals.

During uplink signal transmission, antennas 9 of DUTs 10 may transmit radio-frequency uplink signals. Test antenna 62 may receive the uplink signals. The uplink signals may be routed to tester 22. Tester 22 may perform desired measurements on the uplink signals.

Whether a conducted test setup of the type described in connection with FIG. 2 or a radiated test setup of the type described in connection with FIG. 3 is used, having more than one DUT 10 in a test chamber may involve procedures that mitigate interactions among the multiple DUTs during testing. For example, if DUTs 10 simultaneously transmit radio-frequency signals in the same channel, tester 22 may not be able to separately analyze and perform desired measurements on the radio-frequency signals for each individual DUT 10.

As shown in FIGS. 2 and 3, each test station 13 may be connected to computing equipment 36 through line 38. Computing equipment 36 may include storage equipment on which a database 40 is stored. The test measurements obtained using tester 22 may be stored in database 40.

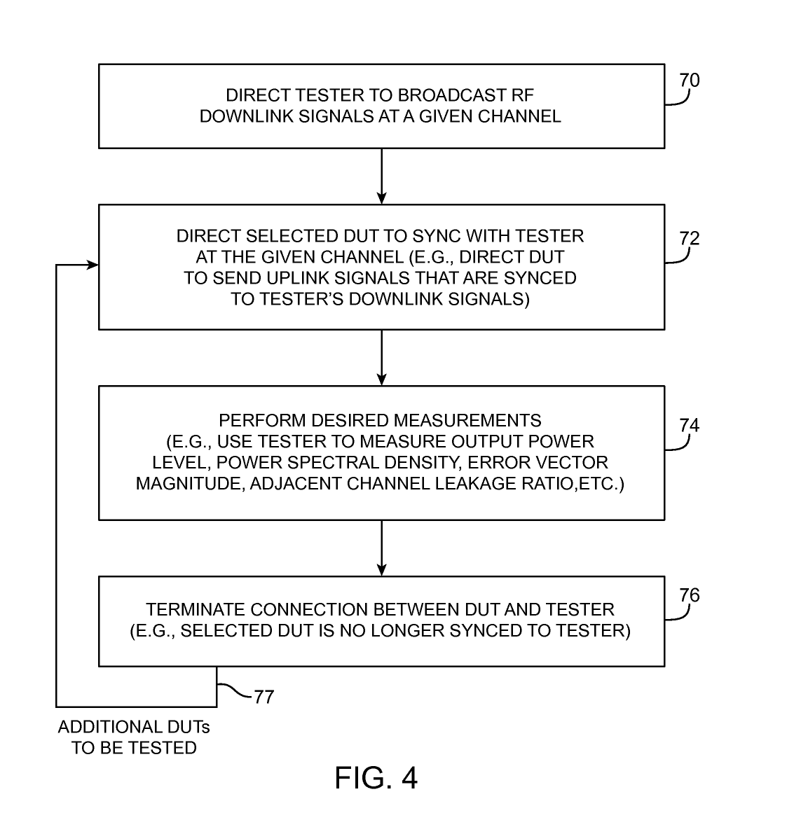

FIG. 4 shows steps involved in testing DUTs 10 using a serial approach. These steps may be used to test DUTs 10 in the conducted and radiated test setup of FIGS. 2 and 3, respectively.

At step 70, test host 26 may direct tester 22 to broadcast radio-frequency downlink test signals at a given channel. The downlink test signals may be grouped into frames for transmission. Each frame may include control information such as a frame header and a frame trailer and may include user data (sometimes referred to as payload). The frame header may include information such as a preamble, start frame delimiter, source and destination address, and other control information, whereas the frame trailer may include information such as cyclic redundancy check bits and other sequencing information (as an example).

At step 72, test host 26 may direct a selected DUT to synchronize (to “sync”) with tester 22 at the given channel (e.g., to synchronize tester 22 to the Global System for Mobile Communications (GSM) time division multiple access (TDMA) timing 26-multiframe structure). Selected DUT 10 is synced when DUT 10 transmits uplink signals with frame headers and trailers that are respectively aligned with the frame headers and trailers of the downlink signals broadcast by tester 22. DUTs other than the selected DUT in the test chamber are not synced to the downlink test signals of tester 22. DUTs other than the selected DUT in the test chamber may be powered off, if desired.

At step 74, tester 22 may be used to perform desired measurements for the uplink signals transmitted by the selected DUT. For example, tester 22 may be used to measure an output power level, power spectral density (PSD), error vector magnitude (EVM), adjacent channel leakage ratio (ACLR), dynamic range, and other performance metrics at desired frequencies.

At step 76, the connection between the selected DUT and tester 22 may be terminated (e.g., the selected DUT may no longer be synced to tester 22 or the selected DUT may be powered off). Processing may loop back to step 72 to test the remaining DUTs in the test chamber, as indicated by path 77.

For example, consider a scenario in which first, second, third, and fourth DUTs 10 are placed in test chamber 32 of FIG. 2. Test host 26 may direct tester 22 to broadcast test downlink signals at 1.1 GHz (as an example). Test host 26 may direct first DUT 10 to sync to the downlink signals. The processing of syncing first DUT 10 to downlink signals at the given channel may, for example, take 5-30 seconds.

When first DUT 10 is synced to the test downlink signals, first DUT 10 may transmit uplink signals at 1 GHz (as an example). Tester 22 may perform desired measurements on the uplink signals in two seconds, whereas disconnecting (unsynchronizing) first DUT 10 may take another 5-30 seconds (as examples). Testing may continue in this way to test second, third, and fourth DUTs 10 before populating test chamber 32 with another set of DUTs 10. Test host 26 and DUTs 10 may respectively transmit downlink and uplink signals at any desired frequency.

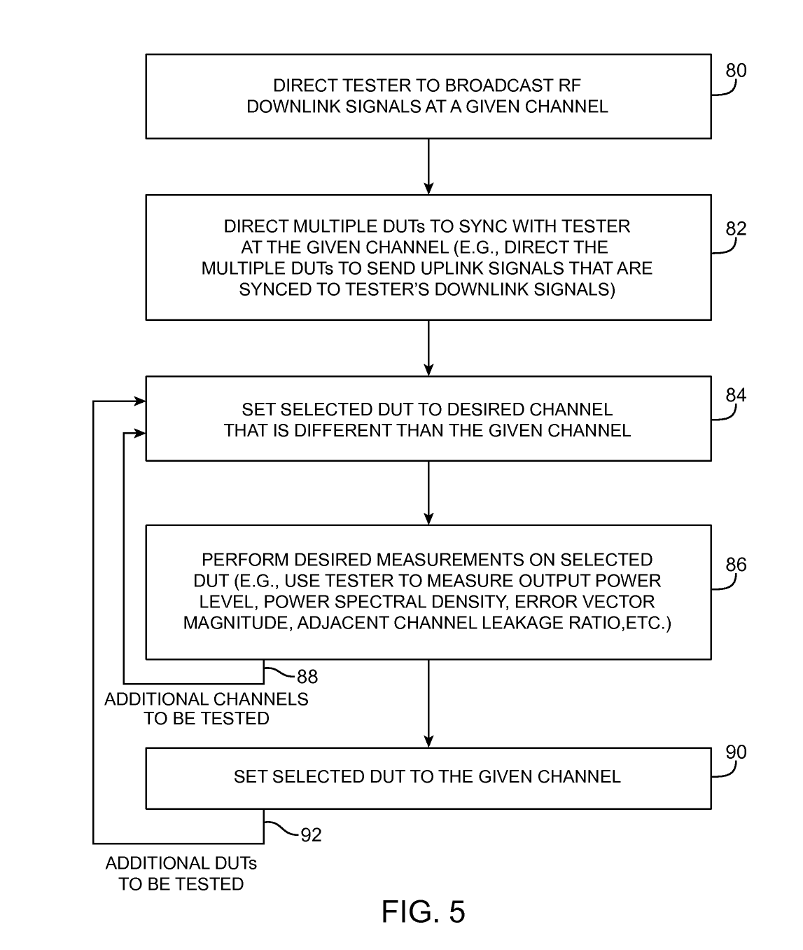

FIG. 5 shows steps involved in testing DUTs 10 using a parallel approach. These steps may be used to test DUTs 10 in the conducted and radiated test setup of FIGS. 2 and 3, respectively.

At step 80, test host 26 may direct tester 22 to broadcast radio-frequency downlink test signals at a given channel. The downlink test signals may be grouped into frames for transmission.

At step 82, test host 26 may direct multiple DUTs to simultaneously sync with tester 22 at the given channel. The multiple DUTs is synced when each of the multiple DUTs transmits uplink signals with frame headers and trailers that are aligned with the frame headers and trailers of the downlink signals broadcast by tester 22.

At step 84, a selected one of the multiple DUTs may be set to a desired channel that is different than the given channel (e.g., the selected DUT may be configured to transmit signals at the desired channel).

At step 86, tester 22 may be used to perform desired measurements on the uplink signals transmitted at the desired channel by the selected DUT (e.g., tester 22 may be configured to listen for signals at the desired channel and to analyze the signals at the desired channel). For example, tester 22 may be used to measure an output power level, power spectral density (PSD), error vector magnitude (EVM), adjacent channel leakage ratio (ACLR), dynamic range, and other performance metrics at the desired frequency. Processing may loop back to step 84 if there are additional channels to be tested for the selected DUT, as indicated by path 88.

At step 90, the selected DUT may be set back to the given channel (e.g., the selected DUT may be reconfigured to transmit uplink signals at the given channel). Processing may loop back to step 84 to test the remaining DUTs in the test chamber, as indicated by path 92.

For example, consider a scenario in which first, second, third, and fourth DUTs 10 are placed in test chamber 64 of FIG. 3. Test host 26 may direct tester 22 to broadcast test downlink signals at 1850 MHz (as an example). Test host 26 may direct first, second, third, and fourth DUTs 10 to sync to the downlink signals. The processing of syncing DUTs 10 to RF signals in parallel may, for example, take 5-30 seconds. First, second, third, and fourth DUTs 10 may transmit uplink signals at 1750 MHz when synced to the downlink signals broadcast by tester 22.

Test host 26 may direct first DUT 10 to transmit uplink signals at an outside channel (e.g., at 900 MHz), which may take 0.1 seconds. Tester 22 may perform desired measurements on the uplink signals at desired frequencies (e.g., 900 MHz, 800 MHz, 700 MHz, etc.) in eight seconds (as an example). Testing may continue in this way to test second, third, and fourth DUTs 10 before populating test chamber 32 with another set of DUTs 10. When testing a successive DUT, the successive DUT need not be synced because the successive DUT has been synced previously during the parallel syncing process. Test host 26 and DUTs 10 may respectively transmit downlink and uplink signals at any desired frequency.

The foregoing is merely illustrative of the principles of this invention and various modifications can be made by those skilled in the art without departing from the scope and spirit of the invention.

What is claimed is:

1. A method of testing devices under test with a test station, wherein the test station includes a tester and a test chamber in which the devices under test are tested, the method comprising:
directing the tester to broadcast radio-frequency downlink signals in a given channel to the devices under test in the test chamber;
directing a selected one of the devices under test to synchronize with the downlink signals broadcast from the tester, wherein the selected device under test transmits uplink signals in the given channel while the selected device under test is synchronized with the downlink signals and while devices under test other than the selected device under test in the test chamber are unsynchronized with the downlink signals; and
with the tester, receiving the uplink signals transmitted from the selected device under test.

2. The method defined in claim 1, further comprising:
with the tester, performing measurements on the received uplinked signals transmitted from the selected device under test.

3. The method defined in claim 2, wherein performing the measurements on the received uplinked signals comprises:
with the tester, measuring a performance metric, wherein the performance metric is an output power level, a power spectral density, an error vector magnitude, or an adjacent channel leakage ratio.

4. The method defined in claim 1, wherein the test station further comprises a test host and wherein directing the tester to broadcast the radio-frequency downlink signals in the given channel comprises:
with the test host, directing the tester to broadcast the radio-frequency downlink signals in the given channel to the devices under test in the test chamber.

5. The method defined in claim 1, wherein the test station further comprises a test host and wherein directing the selected devices under test to synchronize with the downlink signals broadcast from the tester comprises:
with the test host, directing the selected devices under test to synchronize with the downlink signals broadcast from the tester.

6. The method defined in claim 1, further comprising:
disconnecting the selected device under test from the tester.

7. A method of testing devices under test with a test station, wherein the test station includes a tester and a test chamber in which the devices under test are tested, the method comprising:
directing the tester to broadcast radio-frequency downlink signals in a given channel to the devices under test in the test chamber;
directing each of the devices under test to synchronize with the downlink signals broadcast from the tester, wherein each of the devices under test transmits uplink signals in the given channel while being synchronized with the downlink signals;
following synchronization of each of the devices under test to the downlink signals broadcast from the tester, directing a selected one of the devices under test to transmit uplink signals in a selected channel that is different from the given channel; and
with the tester, receiving the uplink signals transmitted from the selected device under test.

8. The method defined in claim 7, further comprising:
with the tester, performing measurements on the received uplinked signals transmitted from the selected device under test.

9. The method defined in claim 8, wherein performing the measurements on the received uplinked signals comprises:
with the tester, measuring a performance metric, wherein the performance metric is an output power level, a power spectral density, an error vector magnitude, or an adjacent channel leakage ratio.

10. The method defined in claim 7, wherein the test station further comprises a test host and wherein directing the tester to broadcast the radio-frequency downlink signals in the given channel comprises:
with the test host, directing the tester to broadcast the radio-frequency downlink signals in the given channel to the devices under test in the test chamber.

11. The method defined in claim 7, wherein the test station further comprises a test host and wherein directing each of the devices under test to synchronize with the downlink signals and directing the selected device under test to transmit uplink signals in the selected channel comprises:
with the test host, directing each of the devices under test to synchronize with the downlink signals broadcast from the tester; and
with the test host, directing the selected device under test to transmit the uplink signals in the selected channel.

12. The method defined in claim 7, further comprising:
after receiving the uplink signals transmitted from the selected device under test with the tester, directing the selected device under test to transmit uplink signals in the given channel.

13. A radio-frequency test station with a test chamber in which a plurality of devices under test is tested, comprising:
a tester; and
a radio-frequency coupling circuit, wherein the devices under test in the test chamber are coupled to the tester through the radio-frequency coupling circuit.

14. The radio-frequency test station defined in claim 13, wherein the radio-frequency coupling circuit comprises a radio-frequency splitter.

15. The radio-frequency test station defined in claim 13, wherein the radio-frequency coupling circuit comprises a radio-frequency combiner.

16. The radio-frequency test station defined in claim 13, further comprising:
a test host, wherein the test host is configured to control the tester and the devices under test during wireless testing.

17. A radio-frequency test station with a test chamber in which a plurality of devices under test is tested, comprising:
a tester; and
an antenna within the test chamber, wherein the antenna is coupled to the tester through radio-frequency cabling and wherein the antenna transmits and receives radio-frequency signals to and from the devices under test during wireless testing.

18. The radio-frequency test station defined in claim 17, where the test chamber comprises a transverse electromagnetic cell.

19. The radio-frequency test station defined in 17, wherein the antenna comprises a microstrip antenna.

20. The radio-frequency test station defined in claim 17, further comprising:
a test host, wherein the test host is configured to control the tester and the devices under test during wireless testing.
